(19) United States
(12) Patent Application Publication
(10) Pub. No.: US 2024/0127780 A1
(43) Pub. Date: Apr. 18, 2024

(54) STABILIZED UNDERWATER MOUNTING DEVICE

(71) Applicant: Chris Isenhower, Tipton, IN (US)

(72) Inventor: Chris Isenhower, Tipton, IN (US)

(21) Appl. No.: 17/964,327

(22) Filed: Oct. 12, 2022

(51) Int. Cl. B63B 49/00; G10K 11/00

(52) U.S. Cl. CPC B63B 49/00; G10K 11/006

(57) ABSTRACT

A stabilized underwater mounting device removably connected to a boat, the stabilized underwater mounting device including a main pole, a mount connector disposed on at least a portion of a first end of the main pole to connect a transducer to the main pole, and a handle disposed on at least a portion of a second end of the main pole to facilitate gripping thereof and move the transducer connected to the main pole in response to an application of force against the handle.

### BACKGROUND

### 1. Field

The present general inventive concept relates generally to fishing, and particularly, to a stabilized underwater mounting device.

### 2. Description of the Related Art

A transducer is a type of fishing equipment used by fishermen to identify what is present underwater. Specifically, the transducer converts electrical signals into sound waves, which is returns underwater to the transducer through echoes, which can be interpreted by the transducer.

However, mounting the transducer on a trolling motor shaft can be a troublesome task for many fishermen. Also, most transducers are fixed to a surface of a boat, such as transom mount transducers and/or in-hull transducers. Moreover, during instances of inclement weather, the transducer is constantly moving from wind and/or rocking water, which makes it difficult to stabilize a camera to ascertain underwater activities.

Therefore, there is a need for a stabilized underwater mounting device to keep a camera and/or a transducer stable underwater and allows movement independent of the boat.

### SUMMARY

The present general inventive concept provides a stabilized underwater mounting device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a stabilized underwater mounting device removably connected to a boat, the stabilized underwater mounting device including a main pole, a mount connector disposed on at least a portion of a first end of the main pole to connect a transducer to the main pole, and a handle disposed on at least a portion of a second end of the main pole to facilitate gripping thereof and move the transducer connected to the main pole in response to an application of force against the handle.

The stabilized underwater mounting device may further include a boat connector disposed on at least a portion of the main pole to connect the main pole to the boat.

The boat connector may include a connecting rod angularly disposed away from the main pole with respect to a first direction, a stabilizing rod angularly disposed away from the connecting rod with respect to a second direction, and a support base disposed on at least a portion of the stabilizing rod to connect the stabilizing rod to the boat and prevent the stabilizing rod from moving off the boat.

The stabilized underwater mounting device may further include a movable connector disposed on at least a portion of the main pole and connected to the boat connector to facilitate movement of the main pole in three hundred sixty degrees.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a stabilized underwater mounting device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Stabilized Underwater Mounting Device 100
Main Pole 110
First Section 111
Second Section 112
Mount Connector 120
Base 121
Connecting Bracket 122
Handle 130
Boat Connector 140
Connecting Rod 141
Stabilizing Rod 142
Rod Connector 143
First Bracket 144
Second Bracket 145
Support Base 146
Movable Connector 150
Support Connector 160

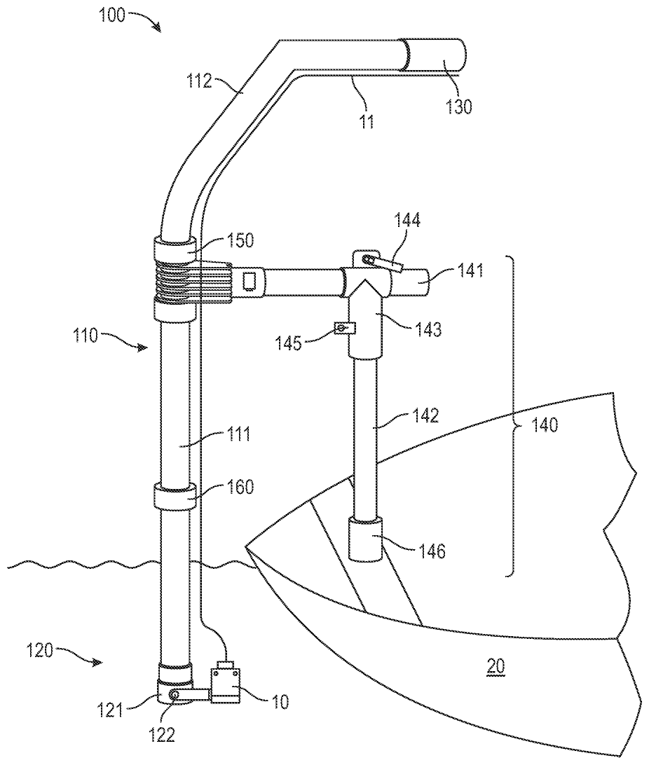

FIG. 1 illustrates a side perspective view of a stabilized underwater mounting device 100, according to an exemplary embodiment of the present general inventive concept.

The stabilized underwater mounting device 100 may be constructed from at least one of metal, plastic, wood, and rubber, etc., but is not limited thereto.

The stabilized underwater mounting device 100 may include a main pole 110, a mount connector 120, a handle 130, a boat connector 140, a movable connector 150, and a support connector 160, but is not limited thereto.

Referring to FIG. 1, the main pole 110 is illustrated to have a cylindrical shape. However, the main pole 110 may be rectangular, circular, triangular, pentagonal, hexagonal, heptagonal, octagonal, or any other shape known to one of ordinary skill in the art, but is not limited thereto.

The main pole 110 may include a first section 111 and a second section 112, but is not limited thereto.

The first section 111 may have an elongate shape. Moreover, the first section 111 may be at least partially inserted below a surface of a body of water (i.e., underwater).

The second section 112 may be disposed on at least a portion of a first end of the first section 111. The second section 112 may have an arcuate and/or a bent shape. As such, the second section 112 may curvedly extend away from the first section 111. The second section 112 may be disposed outside the body of water.

The mount connector 120 may include a base 121 and a connecting bracket 122, but is not limited thereto.

The base 121 may be disposed on at least a portion of a second end of the first section 111 opposite with respect to the first end of the first section 111. The base 121 may be at least partially inserted below the surface of the body of water.

The connecting bracket 122 may be movably (i.e., rotatably, hingedly) disposed on at least a portion of the base 121. The connecting bracket 122 may removably connect (e.g., clamp, clip, screw, bolt, nut, magnet) to at least a portion of a transducer 10 and/or an underwater camera. Accordingly, the connecting bracket 122 may fasten the transducer 10 to the main pole 110. Also, the first section 111 and/or the second section 112 may direct a cable 11 of the transducer 10 along a length of the first section 111 and/or the second section 112.

The handle 130 may be disposed on at least a portion of the second section 112. The handle 130 may facilitate gripping thereof. Also, the first section 111 and/or the second section 112 may move (i.e., rotate, pivot) in response to an application of force (e.g., pushing, pulling) on the handle 130. For example, the first section 111 and/or the second section 112 may rotate three-hundred sixty (360) degrees in response to the application of force. Accordingly, the transducer 10 may rotate 360 degrees while underwater independent of movement of a boat 20.

The boat connector 140 may include a connecting rod 141, a stabilizing rod 142, a rod connector 143, a first bracket 144, a second bracket 145, and a support base 146, but is not limited thereto.

The connecting rod 141 may be angularly (e.g., perpendicularly) disposed away from the first section 111 and/or the second section 112 with respect to a first direction. Moreover, the connecting rod 141 may extend the first section 111 and/or the second section 112 equivalent to a length of the connecting rod 141. The second section 112 may extend beyond the length of the connecting rod 141. In other words, the second section 112 may have a length and/or a curve exceeding the length of the connecting rod 141.

The stabilizing rod 142 may be angularly (e.g., perpendicularly) disposed at a first end away from the connecting rod 141 with respect to a second direction. The stabilizing rod 142 may be removably connected at a second end to at least a portion of the boat 20. The stabilizing rod 142 may prevent the connecting rod 141 from moving.

The rod connector 143 may be disposed between the connecting rod 141 and/or the stabilizing rod 142. More specifically, the rod connector 143 may connect the connecting rod 141 to the stabilizing rod 142.

The first bracket 144 may be movably (i.e., pivotally, rotatably) disposed on at least a portion of the rod connector 143. The first bracket 144 may allow the connecting rod 141 to be extracted from the rod connector 143 in response to moving to a first position. Conversely, the first bracket 144 may prevent the connecting rod 141 from being extracted from the rod connector 143 in response to moving to a second position different from the first position.

The second bracket 145 may be movably (i.e., pivotally, rotatably) disposed on at least a portion of the rod connector 143. The second bracket 145 may allow the stabilizing rod 142 to be extracted from the rod connector 143 in response to moving to a first position. Conversely, the second bracket 145 may prevent the stabilizing rod 142 from being extracted from the rod connector 143 in response to moving to a second position different from the first position.

The support base 146 may include a fastener (e.g., a screw, a nail, a bolt, a nut, a washer, an adhesive (i.e., tape, glue), a magnet, and/or any combination thereof, but is not limited thereto.

The support base 146 may be disposed on at least a portion of the second end of the stabilizing rod 142. The support base 146 may removably connect the stabilizing rod 142 to the boat 20. The support base 146 may prevent the stabilizing rod 142 from moving off the boat 20.

The movable connector 150 may be disposed on at least a portion of the first section 111 and/or the second section 112 between the first section 111 and/or the second section 112. Moreover, the movable connector 150 may connect the first section 111 and/or the second section 112 to the connecting rod 141. The movable connector 150 may facilitate movement (i.e., rotation) of the first section 111 and/or the second section 112, such as 360 degrees while the first section 111 and/or the second section 112 are connected to the boat 20 by the boat connector 140.

The support connector 160 may be disposed on at least a portion of the first section 111. The support connector 160 may prevent damage to the first section 111 from an external object and/or debris in the body of water.

Therefore, the stabilized underwater mounting device 100 may keep the transducer 10 stable in the body of water while connected to the boat 20. Also, the stabilized underwater mounting device 100 may allow independent movement of the transducer 10 due to being separated from the boat 20.

The present general inventive concept may include a stabilized underwater mounting device 100 removably connected to a boat 20, the stabilized underwater mounting device 100 including a main pole 110, a mount connector 120 disposed on at least a portion of a first end of the main pole 110 to connect a transducer 10 to the main pole 110, and a handle 130 disposed on at least a portion of a second end of the main pole 110 to facilitate gripping thereof and move the transducer 10 connected to the main pole 10 in response to an application of force against the handle 130.

The stabilized underwater mounting device 100 may further include a boat connector 140 disposed on at least a portion of the main pole 110 to connect the main pole 110 to the boat 20.

The boat connector 140 may include a connecting rod 141 angularly disposed away from the main pole 110 with respect to a first direction, a stabilizing rod 142 angularly disposed away from the connecting rod 141 with respect to a second direction, and a support base 146 disposed on at least a portion of the stabilizing rod 142 to connect the stabilizing rod 142 to the boat 20 and prevent the stabilizing rod 142 from moving off the boat 20.

The stabilized underwater mounting device 100 may further include a movable connector 150 disposed on at least a portion of the main pole 110 and connected to the boat connector 140 to facilitate movement of the main pole 110 in three hundred sixty degrees.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A stabilized underwater mounting device removably connected to a boat, the stabilized underwater mounting device comprising:
a main pole;
a mount connector disposed on at least a portion of a first end of the main pole to connect a transducer to the main pole;
a handle disposed on at least a portion of a second end of the main pole to facilitate gripping thereof and move the transducer connected to the main pole in response to an application of force against the handle; and
a boat connector disposed on at least a portion of the main pole to connect the main pole to the boat, the boat connector comprising:
a connecting rod angularly disposed away from the main pole with respect to a first direction,
a stabilizing rod angularly disposed away from the connecting rod with respect to a second direction,
a support base disposed on at least a portion of the stabilizing rod to connect the stabilizing rod to the boat and prevent the stabilizing rod from moving off the boat,
a rod connector to contact and connect the connecting rod to the stabilizing rod, and
a first bracket to allow the connecting rod to be extracted from the rod connector in response to moving to a first position, and to prevent the connecting rod from being extracted from the rod connector in response to moving to a second position different from the first position.

2. (canceled)

3. (canceled)

4. The stabilized underwater mounting device of claim 2, further comprising:
a movable connector disposed on at least a portion of the main pole and connected to the boat connector to facilitate movement of the main pole in three hundred sixty degrees.
